(19) United States
(12) Patent Application Publication
(10) Pub. No.: US 2021/0129319 A1
(43) Pub. Date: May 6, 2021

(54) CONTROLLER, CONTROL METHOD, AND COMPUTER PROGRAM PRODUCT

(71) Applicant: KABUSHIKI KAISHA TOSHIBA, Minato-ku (JP)

(72) Inventors: Toshimitsu KANEKO, Kawasaki (JP); Tatsuya Tanaka, Kawasaki (JP); Masahiro Sekine, Fuchu (JP)

(73) Assignee: KABUSHIKI KAISHA TOSHIBA, Minato-ku (JP)

(21) Appl. No.: 17/004,292

(22) Filed: Aug. 27, 2020

(30) Foreign Application Priority Data
Nov. 1, 2019 (JP) 2019-200061

(51) Int. Cl. B25J 9/16; B25J 13/08; G06N 3/04; G06N 3/08

(52) U.S. Cl. CPC B25J 9/1612; B25J 9/161; G06N 3/084; B25J 13/089; G06N 3/0454; B25J 9/163

(57) ABSTRACT

A controller includes one or more processors. The processors acquire first state information indicating a state of an object to be gripped by a robot and second state information indicating a state of a transportation destination of the object. The processors input the first state information and the second state information to a first neural network, and obtain, from output of the first neural network, first output information including a first position indicating a position of the robot and a first posture indicating a posture of the robot when the robot grips the object, and a second position indicating a position of the robot and a second posture indicating a posture of the robot at the transportation destination of the object. The processors control operation of the robot on the basis of the first output information.

### CROSS-REFERENCE TO RELATED APPLICATIONS

This application is based upon and claims the benefit of priority from Japanese Patent Application No. 2019-200061, filed on Nov. 1, 2019; the entire contents of which are incorporated herein by reference.

### FIELD

Embodiments described herein relate generally to a controller, a control method, and a computer program product.

### BACKGROUND

In packing and loading of articles by robots, occupancy rates of packed and loaded containers are desired to be increased for efficient use of storage space and efficient transportation. As techniques enabling high occupancy rate packing in accordance with kinds and ratios of packing objects, techniques have been proposed that determine packing positions using machine learning.

### BRIEF DESCRIPTION OF THE DRAWINGS

FIG. 1 is a diagram illustrating an exemplary structure of a robot system according to a first embodiment;

FIG. 2 is a functional block diagram of a controller according to the first embodiment;

FIG. 3 is a diagram illustrating an exemplary structure of a neural network;

FIG. 4 is a flowchart illustrating exemplary control processing in the first embodiment;

FIG. 5 is a diagram illustrating an exemplary structure of a neural network when parameters of the neural network are learned;

FIG. 6 is a flowchart illustrating exemplary learning processing in the first embodiment;

FIG. 7 is a diagram illustrating an exemplary display screen displayed on a display unit;

FIG. 8 is a functional block diagram of a controller according to a second embodiment;

FIG. 9 is a flowchart illustrating exemplary control processing in the second embodiment;

FIG. 10 is a flowchart illustrating exemplary learning processing in the second embodiment; and

FIG. 11 is a hardware structural diagram of the controller according to the first or the second embodiment.

### DETAILED DESCRIPTION

According to one embodiment, a controller includes one or more processors. The processors acquire first state information indicating a state of an object to be gripped by a robot and second state information indicating a state of a transportation destination of the object. The processors input the first state information and the second state information to a first neural network, and obtain, from output of the first neural network, first output information including a first position indicating a position of the robot and a first posture indicating a posture of the robot when the robot grips the object, and a second position indicating a position of the robot and a second posture indicating a posture of the robot at the transportation destination of the object. The processors control operation of the robot on the basis of the first output information.

The following describes preferred embodiments of a controller according to the invention in detail with reference to the accompanying drawings. The following describes mainly a robot system that controls a robot having a function of gripping an article (an example of the object), transporting the gripping article, and packing the article in a container (an example of the transportation destination). The system to which the invention can be applied is not limited to such a robot system.

In the robot system described above, a position and a posture that allow the object to be packed are restricted depending on how the robot grips the packing object in some cases. In such a case, the robot cannot necessarily pack the packing object as planned. There is a case where efficient operation cannot be produced when planning the operation of transferring the object due to a singularity or other reasons depending on a combination of a gripping position and a packing position. In such a case, the robot's operation takes a long time. As a result, the packing work takes a long time in some cases. After the packing object is gripped, it is possible to determine an optimum packing position out of the positions at which the object can be packed. Such a technique, however, cannot select an optimum combination out of all of the combinations of the gripping position and the packing position because the gripping way has been already determined.

### First Embodiment

A controller according to a first embodiment plans (infers) a position at which the packing object is gripped (a gripping position) and a posture of the object at the gripping (a gripping posture), and a position at which the object is packed (a packing position) and a posture of the object at the packing (a packing posture). As a result, efficient packing can be planned that can be performed by the robot and has a high occupancy rate or is performed in a short working time. The packing that can be performed by the robot means that the object can be packed without colliding with a container and other things, for example.

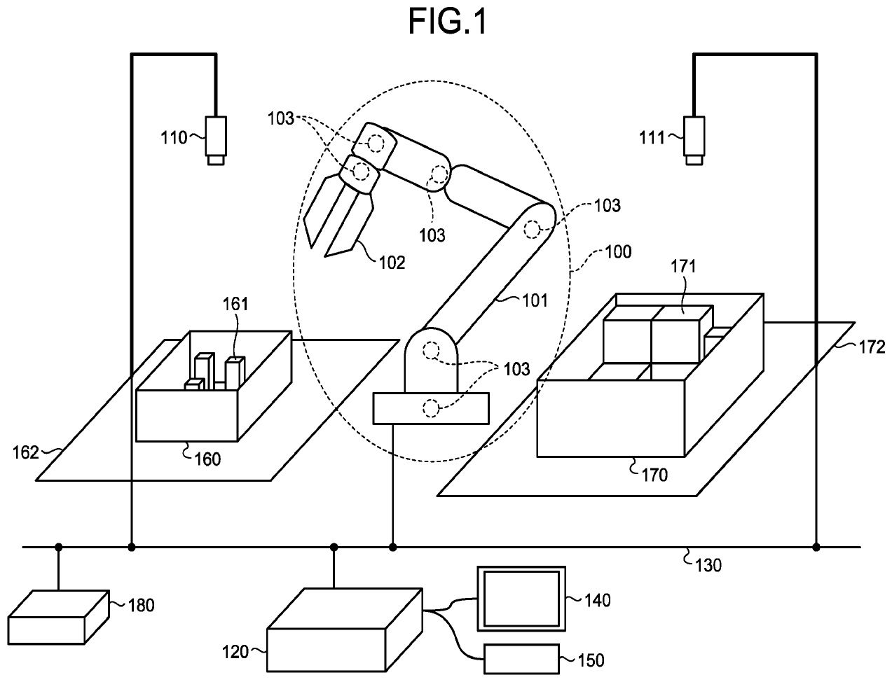

FIG. 1 is a diagram illustrating an exemplary structure of a robot system including a controller 120 according to the first embodiment. As illustrated in FIG. 1, the robot system in the first embodiment includes a robot 100, a generation unit 110, a generation unit 111, the controller 120, a network 130, a display unit 140, an input unit 150, a container 160, a container 170, and a simulator 180.

The robot 100 has a function of transporting an operation object 161 from the container 160 to the container 170. The robot 100 can be formed by an articulated robot, a Cartesian coordinate robot, and a combination of those robots, for example. The following describes an example where the robot 100 is an articulated robot that includes an articulated arm 101, an end effector 102, and a plurality of actuators 103.

The end effector 102 is attached to the distal end of the articulated arm 101 for transporting the object (e.g., an article). The end effector 102 is a gripper that can grip the object, or a vacuum robot hand, for example. The articulated arm 101 and the end effector 102 are controlled in accordance with driving of the actuators 103. More specifically, the articulated arm 101 moves, rotates, and performs expansion and contraction (i.e., changes angles between joints) in accordance with driving of the actuators 103. The end effector 102 grips (grips or sucks) the object and cancels (releases) the gripping in accordance with driving of the actuators 103.

The controller 120 controls operation of the robot 100. The controller 120 can be achieved as a computer and a dedicated controller that controls the operation of the robot 100, for example. Details of the functions of the controller 120 are described later.

The network 130 connects constituent components such as the robot 100, the generation units 110 and 111, and the controller 120. The network 130 is a local area network (LAN) or the Internet, for example. The network 130 may be a wired network or a wireless network. The robot 100, the generation units 110 and 111, and the controller 120 can interchange data (signals) among them via the network 130. The interchange of data may be performed directly among the components in a wired connection or a wireless connection manner without using the network 130.

The display unit 140 is a device that displays information used by the controller 120 for various types of processing. The display unit 140 can be formed by a display device such as a liquid crystal display (LCD), for example. The display unit 140 can display settings of the robot 100, a state of the robot 100, and a state of work performed by the robot 100, for example.

The input unit 150 is an input device that includes a keyboard and a pointing device such as a mouse. The display unit 140 and the input unit 150 may be built into the controller 120.

The robot 100 works to grip an object placed in the container 160 (the first container) and packs the object in the container 170 (the second container). The container 170 may be empty or already packed with objects 171. The container 160 is a container (box) used for storing or transporting articles in a warehouse, for example. The container 170 is a container (box) used for shipment, for example. The container 170 is a corrugated board box or a transportation pallet, for example.

The container 160 is disposed on a workbench 162 and the container 170 is disposed on a workbench 172. The containers 160 and 170 may be disposed on respective belt conveyors that can convey corresponding one of the containers 160 and 170. In this case, the containers 160 and 170 are disposed in a movable range of the robot 100 by being conveyed by the respective belt conveyors.

The object 161 and/or the object 171 may be directly disposed on a working region (an example of the transportation destination) such as a belt conveyor or a wagon, for example, without use of at least one of the containers 160 and 170.

The generation unit 110 produces state information (the first state information) that indicates a state of the object 161. The generation unit 111 produces state information (the second state information) that indicates a state of the transportation destination of the object 161. The generation units 110 and 111 are cameras that produce images, and distance sensors that produce depth images (depth data), for example. The generation units 110 and 111 may be placed in an environment (e.g., on a post and on a ceiling of a room) including the robot 100, or attached to the robot 100.

When a three-dimensional coordinate system, which includes an XY plane parallel to the workbench 162, and a Z axis in the direction perpendicular to the XY plane, is used, an image is produced by a camera having an imaging direction parallel to the Z axis, for example. A depth image is produced by a distance sensor having a ranging direction parallel to the Z axis, for example. The depth image is information that indicates a depth value of each position (x,y) on the XY plane in the Z axis direction, for example.

The generation unit 110 observes at least a part of the state of the object 161 in the container 160 to produce the state information, for example. The state information includes at least one of the image and the depth image of the object 161, for example.

The generation unit 111 observes at least a part of the container 170 to produce the state information, for example. The state information includes at least one of the image and the depth image of the container 170, for example.

The generation units 110 and 111 may be integrated to a single generation unit. In this case, the single generation unit produces the state information about the object 161 and the state information about the container 170. Three or more generation units may be included.

The controller 120 produces an operation plan to grip at least one object 161, transport the object 161, and pack the object 161 in the container 170 using the pieces of state information produced by the generation units 110 and 111.

The controller 120 sends control signals based on the produced operation plan to the actuators 103 of the robot 100 to cause the robot 100 to operate.

The simulator 180 simulates the operation of the robot 100. The simulator 180, which is achieved as an information processor such as a computer, for example, is used for learning and evaluating the operation of the robot 100. The robot system may not include the simulator 180.

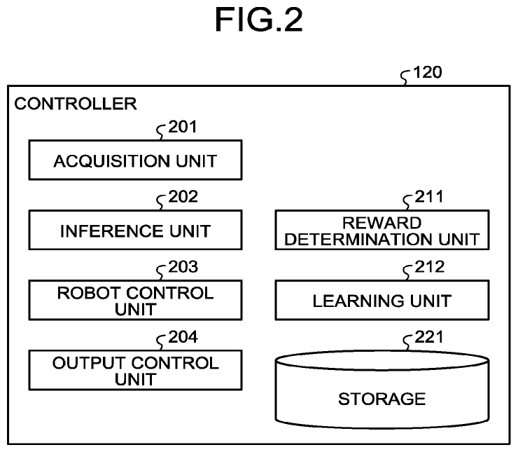

FIG. 2 is a block diagram illustrating an exemplary functional structure of the controller 120. As illustrated in FIG. 2, the controller 120 includes an acquisition unit 201, an inference unit 202, a robot control unit 203, an output control unit 204, a reward determination unit 211, a learning unit 212, and storage 221.

The storage 221 stores therein various types of information used for various types of processing performed by the controller 120. For example, the storage 221 stores therein the state information acquired by the acquisition unit 201 and parameters of a model (a neural network) used by the inference unit 202 for inference. The storage 221 can be formed by various generally used storage media such as a flash memory, a memory card, a random access memory (RAM), a hard disk drive (HDD), and an optical disc.

The acquisition unit 201 acquires various types of information used for various types of processing performed by the controller 120. For example, the acquisition unit 201 acquires (receives) the pieces of state information from the generation units 110 and 111 via the network 130. When outputting the acquired pieces of state information to the inference unit 202, the acquisition unit 201 may output the acquired pieces of state information as is or after performing various types of processing such as resolution conversion, frame rate conversion, clipping, and trimming on the pieces of state information. In the following description, the state information acquired from the generation unit 110 is described as state information S₁ while the state information acquired from the generation unit 111 is described as state information S₂.

The inference unit 202 plans the gripping position and the gripping posture when the robot 100 grips the object 161 in the container 160, and the packing position and the packing posture when the robot 100 packs the object 161 in the container 170 using the state information S₁ and the state information S₂. For example, the inference unit 202 inputs the state information S₁ and the state information S₂ to a neural network (the first neural network), and obtains output information (the first information) that includes the gripping position and the gripping posture (the first position and the first posture) and the packing position and the packing posture (the second position and the second posture) from the output of the neural network with respect to the input. The output information corresponds to the information indicating the operation plan from gripping of the object to packing of the object in the container 170.

The gripping position represents the coordinate values that determine the position of the end effector 102 at the gripping of the object 161. The gripping posture represents the orientation or the inclination of the end effector 102 at the gripping of the object 161, for example. The packing position represents the coordinate values that determine the position of the end effector 102 at the placing of the object 161. The packing posture represents the orientation or the inclination of the end effector 102 at the placing of the object 161, for example. The coordinate values determining the position are represented by coordinate values (x,y,z) in the predetermined three-dimensional coordinate system, for example. The orientation or the inclination is represented by rotation angles (θₓ, θ_{y}, θ_{z}) around respective axes of the three-dimensional coordinate system, for example.

The robot control unit 203 controls the robot 100 such that the robot 100 grips and packs the object 161 at the planned positions and postures, on the basis of the output information from the inference unit 202. The robot control unit 203 produces control signals for the actuators 103 to cause the robot 100 to perform the following exemplary operation.

Operation to cause the robot 100, from the current state, to grip the object 161 at the gripping position and the gripping posture that are planned by the inference unit 202.

Gripping operation of the object 161.

Operation to cause the object 161 to be transported to the packing position and the packing posture that are planned by the inference unit 202.

Operation to place the object 161.

Operation to cause the robot 100 to be in a desired state after the packing.

The robot control unit 203 sends the produced control signals to the robot 100 via the network 130, for example. In accordance with the driving of the actuators 103 according to the control signals, the robot 100 operates to grip and pack the object 161.

The output control unit 204 controls the output of the various types of information used for the various types of processing performed by the controller 120. For example, the output control unit 204 controls the processing to display the output of the neural network on the display unit 140.

The reward determination unit 211 and the learning unit 212 serve as a structural unit used for learning processing of the neural network. When the learning processing is performed other than the controller 120 (e.g., by a learning device other than the controller 120), the controller 120 may not include the reward determination unit 211 and the learning unit 212. In this case, for example, parameters (such as weights and biases) of the neural network learned by the learning device may be stored in the storage 221 such that the inference unit 202 can refer to the parameters. The following describes an example where the learning unit 212 learns the neural network by reinforcement learning.

The reward determination unit 211 determines a reward used by the learning unit 212 in the learning processing of the neural network. For example, the reward determination unit 211 determines a value of the reward used in the reinforcement learning on the basis of the operation result of the robot 100. The reward is determined in accordance with the result of the gripping and the packing of the object 161 according to the plan input to the robot control unit 203. When the gripping and packing of the object 161 is successful, the reward determination unit 211 determines the reward to be a positive value. In the determination, the reward determination unit 211 may change the value of the reward on the basis of the volume and the weight of the object 161, for example. The reward determination unit 211 may determine the reward such that the reward is increased as the working time taken by the robot from the gripping to the packing is shortened.

The reward determination unit 211 determines the reward to be a negative value in the following cases.

A case where the gripping of the object 161 is failed.

A case where the object 161 collides with (makes contact with) the container 160, the container 170, or the object 171, for example, in transportation and at packing of the object 161.

A case where the object 161 is packed in a state different from the planned position and posture.

The learning unit 212 performs the learning processing (reinforcement learning) of the neural network. For example, the learning unit 212 learns the neural network on the basis of the state information S₁, the state information S₂, the reward input from the reward determination unit 211, and the plan performed by the learning unit 212 in the past.

The respective units (the acquisition unit 201, the inference unit 202, the robot control unit 203, the output control unit 204, the reward determination unit 211, and the learning unit 212) are achieved by one or more processors, for example. For example, the respective units may be achieved by a program executed by the processor such as a central processing unit (CPU), i.e., achieved by software. The respective units may be achieved by the processor such as a dedicated integrated circuit (IC), i.e., achieved by hardware. The respective units may be achieved using both software and hardware. When the multiple processors are used, each processor may achieve one of the units or two or more of the units.

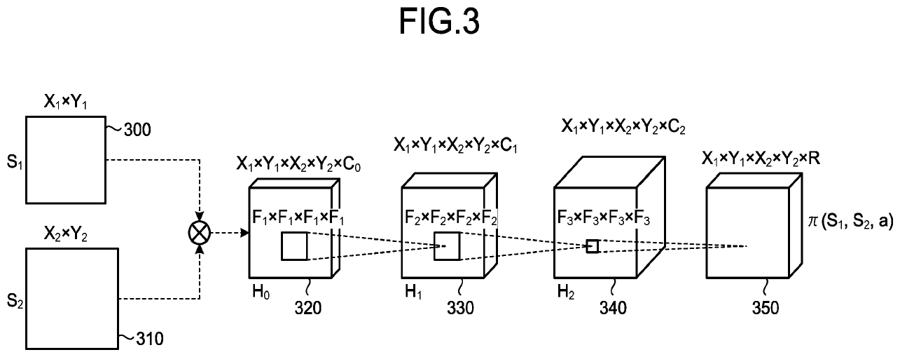

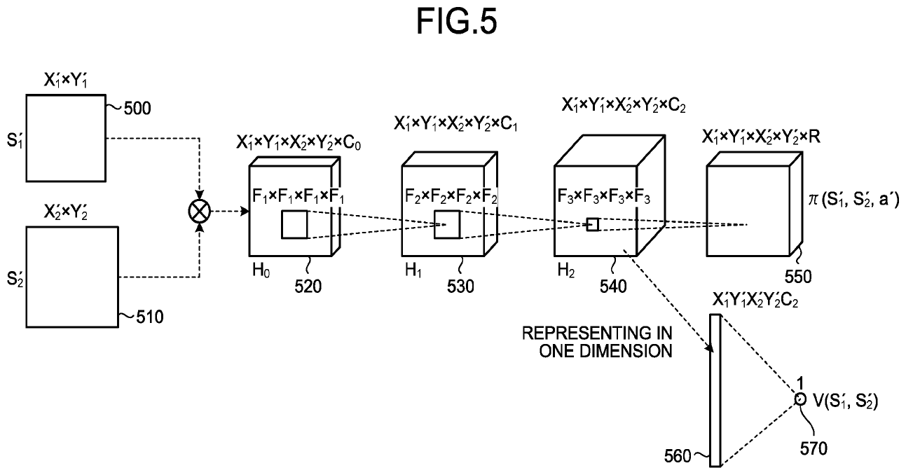

The following describes the details of inference processing by the inference unit 202. As described above, the inference unit 202 infers the gripping position, the gripping posture, the packing position, and the packing posture using the neural network, for example. FIG. 3 is a diagram illustrating an exemplary structure of the neural network. FIG. 3 illustrates an example of the neural network including an intermediate layer composed of three convolution layers. For the purpose of explanation, arrays 320, 330, 340, and 350 are each represented in a three-dimensional data form. However, the data is actually five-dimensional data (the same applies in FIG. 5).

The following describes an example where a depth image is used as the state information. The same method described below can be applied to when an image is used as the state information and when both image and depth image are used as the state information.

State information 300 is the state information S₁ input from the acquisition unit 201. In the explanation, the state information 300 is a depth image composed of X₁ row by Y₁ column of depth values. X₁ is a value corresponding to the length in the X-axis direction (the width) of the container 160, and Y₁ is a value corresponding to the length in the Y-axis direction (the length) of the container 160, for example.

State information 310 is the state information S₂ input from the acquisition unit 201. In the explanation, the state information 310 is a depth image composed of X₂ row by Y₂ column of depth values. X₂ is a value corresponding to the length in the X-axis direction (the width) of the container 170, and Y₂ is a value corresponding to the length in the Y-axis direction (the length) of the container 170, for example.

In the matrix of the state information 300, the component (x₁, y₁) is expressed as S₁(x₁,y₁) where 0≤x₁≤X₁−1 and 0≤y₁≤Y₁−1. In the matrix of the state information 310, the component (x₂, y₂) is expressed as S₂(x₂, y₂) where 0≤x₂≤X₂−1 and 0≤y₂≤Y₂−1.

The inference unit 202 calculates the array 320, which has a size of X₁×Y₁×X₂×Y₂×C₀ and serves as input of the neural network, from the two matrices (the state information 300 and the state information 310). For example, the inference unit 202 calculates the component H₀ of the array 320 as H₀ (x₁, y₁, x₂, y₂, 0) =S₁ (x₁, y₁) and H₀ (x₁, y₁, x₂, y₂,1)=S₂ (x₂, y₂) where C₀=2.

When the state information S₁ and the state information S₂ that are input from the acquisition unit 201 are three-channel images, the inference unit 202 calculates the component H₀ of the array 320 as follows: H₀ (x₁, y₁, x₂, y₂,i)=S₁(x₁, y₁,i) when 0≤i≤2, and H₀ (x₁, y₁, x₂, y₂, i)=s₂ (x₂, y₂, i−3) when 3≤i≤5 where C₀=6. S₁ (x₁ , y₁, i) is the ith channel of the image S₁ while S₂ (x₂, y₂, i) is the ith channel of the image S₂.

When the containers 160 are sequentially placed one by one by a belt conveyor, for example, the depth images of a plurality of containers 160 to be placed sequentially may be included in the state information 300. Likewise, the depth images of a plurality of containers 170 may be included in the state information 310.

For example, when the depth images of M number of containers 160 are processed as the state information 300 and the depth images of N number of containers 170 are processed as the state information 310 at once, the inference unit 202 calculates the component H₀ as H₀ (x₁, y₁, x₂, y₂, c)=S₁^{m}(x₁, y₁)×S₂ⁿ(x₂, y₂) where C₀=M×N. S₁^{m}(x₁, y₁) is the component (x₁, y₁) of the depth image of the m-th (0≤m≤M−1) container 160, and S₂ⁿ(x₂, y₂) is the component (x₂, y₂) of the depth image of the n-th (0≤n≤N−1) container 170. c is determined such that m and n are uniquely determined (e.g., c=m×N+n).

After the calculation, the inference unit 202 may perform the processing that multiplies the array 320 by a statistic value and a constant that are calculated from the distribution of the components of the state information 300 and the state information 310, and perform the processing that clips the upper limit and the lower limit on the array 320.

Then, the inference unit 202 calculates the array 330, which has a size of X₁×Y₁×X₂×Y₂×C₁, by performing convolution calculation on the array 320. This convolution calculation corresponds to the computation of the first convolution layer out of the three convolution layers. A convolution filter, which has a size of F₁×F₁×F₁×F₁, is a fourth dimensional filter. The number of output channels is C₁. The sizes of the respective dimensions of the filter may not be the same. The values of the weights and the biases of the filter are those already learned by a method described later. After the convolution calculation, conversion processing by an activation function such as a rectified linear function or a sigmoid function may be added.

Then, the inference unit 202 calculates the array 340, which has a size of X₁×Y₁×X₂×Y₂×C₂, by performing convolution calculation on the array 330. This convolution calculation corresponds to the computation of the second convolution layer out of the three convolution layers. The convolution filter, which has a size of F₂×F₂×F₂×F₂, is a fourth dimensional filter. The number of output channels is C₂. In the same manner as the first convolution calculation, the sizes of the respective dimensions of the filter may not be the same. The values of the weights and the biases of the filter are those already learned by the method described later. After the convolution calculation, conversion processing by an activation function such as a rectified linear function or a sigmoid function may be added.

Then, the inference unit 202 calculates the array 350, which has a size of X₁×Y₁×X₂×Y₂×R, by performing the convolution calculation on the array 340 as the convolution calculation of the third convolution layer. R is the total number of combinations of an angle of the end effector 102 at the gripping and an angle of the end effector 102 at the packing. The number of combinations of the angle of the end effector 102 at the gripping and the angle of the end effector 102 at the packing is already determined to be a limited number. Each of the integers from 1 to R is allocated for one of the combinations such that the numbers do not overlap.

The component (x₁, y₁, x₂, y₂, r) (1≤r≤R) of the array 350 corresponds to goodness (evaluation value) of the plan when the gripping position is the position corresponding to the component (x₁, y₁) in the depth image of the state information 300, the packing position is the position corresponding to the component (x₂, y₂) in the depth image of the state information 310, and the angle of the end effector 102 at the gripping and the angle of the end effector 102 at the packing are the angles corresponding to the combination identified with r.

The inference unit 202, thus, searches for the component having a larger evaluation value than those of other components, e.g., the component of the array 350 corresponding to the maximum evaluation value, and outputs the plan corresponding to the searched component. The inference unit 202 may calculate probability values by converting the array 350 using a softmax function, and output the respective plans on the basis of sampling according to the calculated probability values. In FIG. 3, π(S₁, S₂, a) represents a probability value of action a under the state information S₁ and the state information S₂.

The intermediate layer of the neural network illustrated in FIG. 3 is composed of only three convolution layers. The intermediate layer can be composed of any number of convolution layers. The intermediate layer of the neural network may further include one or more pooling layers besides the convolution layers. In the example illustrated in FIG. 3, the arrays (arrays 330 and 340), which are output of the intermediate layer, have the same size except for that the number of channels. The intermediate layer can output the arrays having different sizes from one another.

A plurality of pieces of state information, such as the state information 300 and the state information 310, may be batched in groups and processing may be performed at once. For example, the inference unit 202 inputs respective groups in parallel into each neural network such as that illustrated in FIG. 3 to perform inference processing.

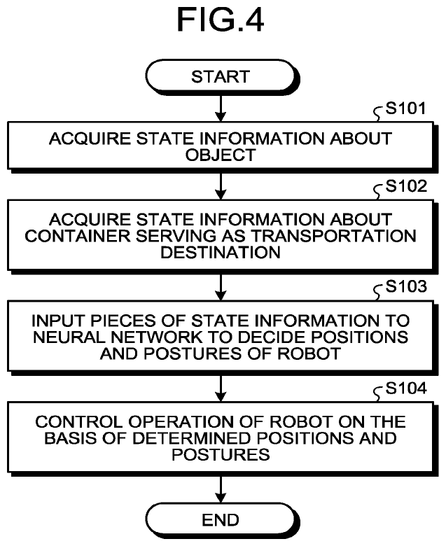

The following describes control processing by the controller 120 thus structured according to the first embodiment. FIG. 4 is a flowchart illustrating exemplary control processing in the first embodiment.

The acquisition unit 201 acquires the state information S₁ about the object 161 from the generation unit 110 (step S101). The acquisition unit 201 acquires the state information S₂ about the container 170 serving as the transportation destination from the generation unit 111 (step S102).

The inference unit 202 inputs the acquired state information S₁ and state information S₂ to the neural network, and determines the gripping position, the gripping posture, the packing position, and the packing posture of the robot 100 from the output of the neural network (step S103).

The robot control unit 203 controls the operation of the robot 100 such that the robot 100 achieves the determined gripping position, gripping posture, packing position, and packing posture (step S104).

The following describes the learning processing by the learning unit 212 in detail. FIG. 5 is a diagram illustrating an exemplary structure of a neural network when parameters of the neural network illustrated in FIG. 3 are learned. The learning unit 212 can use various reinforcement learning methods such as Q-Learning, Sarsa, REINFORCE, and Actor-Critic. The following describes an example where Actor-Critic is used.

State information 500 is state information S′₁ input from the acquisition unit 201. The state information 500 is a depth image represented by an X′₁ row by Y′₁ column of depth values. The intermediate layer of the neural network is composed of only convolution layers. X′₁ and Y′₁, which are the sizes of the depth image at the learning, may be the same as X₁ and Y₁, which are the sizes of the depth image at the inference illustrated in FIG. 3, respectively, or may be different from those. Particularly, the number of input patterns at the learning can be more reduced than the number of input patterns at the inference by setting X′₁<X₁ and Y′₁<Y₁. This can achieve efficient learning.

State information 510 is state information S′₂ input from the acquisition unit 201. The state information 510 is a depth image represented by an X′₂ row by Y′₂ column of depth values. X′₂ and Y′₂ may be the same values as X₂ and Y₂ illustrated in FIG. 3, respectively, or may be different from those. Particularly, efficient learning can be achieved by setting X′₂<X₂ and Y′₂<Y₂.

The learning unit 212 calculates an array 520, which has a size of X′₁×Y′1×X′₂×Y′₂×C₀ and serves as input of the neural network, from the two matrices (the state information 500 and the state information 510) by the same computation as that used to calculate the array 320 illustrated in FIG. 3.

Then, the learning unit 212 calculates an array 530, which has a size of X′₁×Y′1×X′₂×Y′₂×C₁, by performing convolution calculation on the array 520. The convolution filter has the same size as the convolution filter used in calculation of the array 320 illustrated in FIG. 3. The learning unit 212 sets random values to the weights and biases of the filter at the start of the learning, and updates the values of the weights and biases by backpropagation in the learning process. When the activation function is used after the convolution calculation, the learning unit 212 uses the same activation function as that used in calculation of the array 320 illustrated in FIG. 3.

By repeating the convolution calculation in the same manner as described above, the learning unit 212 calculates an array 540, which has a size of X′₁×Y′₁×X′₂×Y′₂×C₁, and an array 550, which has a size of X′₁×Y′₁×X′₂×Y′₂×R.

At the end, the learning unit 212 plans the gripping position, the gripping posture, the packing position, and the packing posture from the array 550 in the same manner as the processing to plan the gripping position, the gripping posture, the packing position, and the packing posture from the array 350 described in FIG. 3.

A vector 560 is a vector representing the array 540 in one dimension. The learning unit 212 calculates a scalar 570 by performing fully connected layer computation on the vector 560. The scalar 570 is a value called a value function (in FIG. 5, V(S′₁, S′₂)) in the reinforcement learning.

At the start of the learning, the learning unit 212 sets random values to the weights and biases used in the fully connected layer computation, and updates the values of the weights and biases by the backpropagation in the learning process. This fully connected layer processing is required only for learning.

The robot control unit 203 controls the operation of the robot 100 such that the robot 100 grips the object 161, transports the object 161, and packs the object 161 on the basis of the gripping position, the gripping posture, the packing position, and the packing posture that are planned from the array 550.

The reward determination unit 211 determines the value of the reward on the basis of the operation and sends the reward to the learning unit 212. The learning unit 212 updates, by backpropagation, the weights and biases of the fully connected layer and the weights and biases of the convolution layers on the basis of the reward sent from the reward determination unit 211 and the calculation result of the scalar 570. The learning unit 212 performs update processing on the weights and biases of the convolution layers by backpropagation on the basis of the reward sent from the reward determination unit 211, the calculation result of the scalar 570, and the calculation result of the array 550. The update amounts of the weights and the biases can be calculated by the method described in Richard S. Sutton and Andrew G. Barto, “Reinforcement Learning: An Introduction” second edition, MIT Press, Cambridge, Mass., 2018, for example.

The learning unit 212 may change the sizes of the state information 500 and the state information 510 in the learning. For example, the learning unit 212 sets the respective values of X′₂, Y′₂, X′₂, and Y′₂ to small values and changes those values to larger values step by step as the learning advances. Such control can further increase learning efficiency.

The learning unit 212 may learn the neural network by actually operating the robot 100 or by simulation operation using the simulator 180. The neural network is not necessarily learned by reinforcement learning. The neural network may be learned by supervised learning with teaching data.

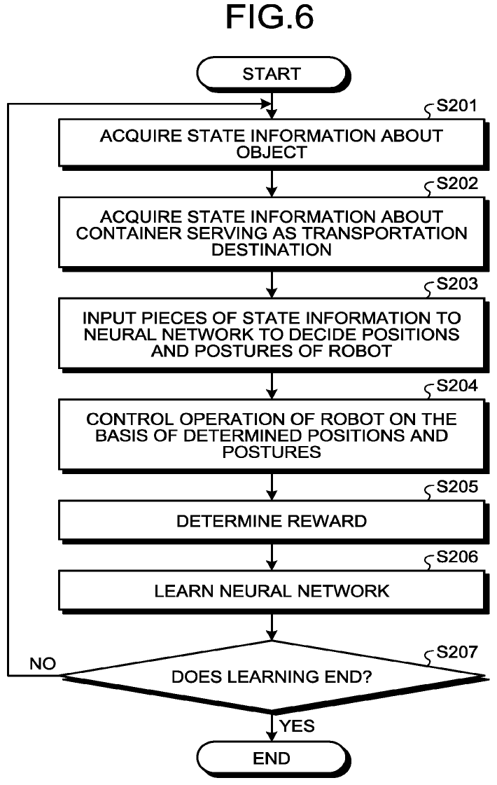

The following describes the learning processing by the controller 120 thus structured according to the first embodiment. FIG. 6 is a flowchart illustrating exemplary learning processing in the first embodiment.

The acquisition unit 201 acquires the state information S′₁ about the object 161 from the generation unit 110 (step S201). The acquisition unit 201 acquires the state information S′₂ about the container 170 serving as the transportation destination from the generation unit 111 (step S202).

The learning unit 212 inputs the acquired state information S′₁ and state information S′₂ to the neural network, and determines the gripping position, the gripping posture, the packing position, and the packing posture of the robot 100 from the output of the neural network (step S203).

The robot control unit 203 controls the operation of the robot 100 such that the robot 100 achieves the determined gripping position, gripping posture, packing position, and packing posture (step S204).

The reward determination unit 211 determines the value of the reward on the basis of the operation result of the robot 100 (step S205). The learning unit 212 updates the weights and biases of the convolution layers by backpropagation using the value of the reward and the output (the calculation result of the scalar 570 and the calculation result of the array 550) of the neural network (step S206).

The learning unit 212 determines whether the learning ends (step S207). For example, the learning unit 212 determines the end of the learning on the basis of whether the value of the value function is converged or whether the number of repetitions of learning reaches the upper limit value. If the leaning continues (No at step S207), the processing returns to step S201, where the processing is repeated. If it is determined that the learning ends (Yes at step S207), the learning processing ends.

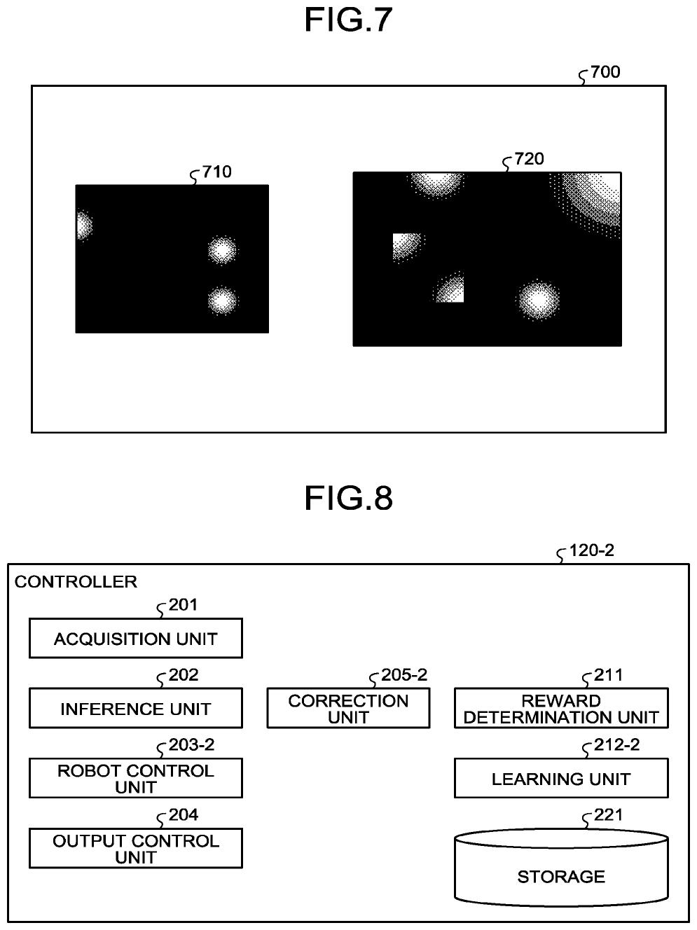

The following describes output control processing by the output control unit 204 in detail. FIG. 7 is a diagram illustrating an example of a display screen 700 displayed on the display unit 140. The display screen 700 includes an image 710 that displays evaluation results (evaluation values) of the gripping positions at respective positions in the container 160 and an image 720 that displays evaluation results (evaluation values) of the packing positions at respective positions in the container 170. In the image 710, as the gripping position has a higher evaluation, the gripping position is displayed brighter. In the image 720, as the packing position has a higher evaluation, the packing position is displayed brighter. The evaluations of the gripping positions and the packing positions are values calculated from the array 550.

The output control unit 204 causes the images 710 and 720 to be displayed while the robot 100 is operated, for example. As a result, it can be checked whether the gripping positions and the packing positions are appropriately calculated. The output control unit 204 may cause the images 710 and 720 to be displayed before the robot 100 is operated. As a result, it can be checked whether the processing by the inference unit 202 has a drawback before the operation of the robot.

In FIG. 7, only the evaluation results of the gripping positions and the packing positions are displayed. The output control unit 204 may also display the evaluation results of the postures in an understandable manner. For example, the output control unit 204 displays the respective gripping positions, packing positions, and optimum postures (orientations) with different colors from one another. For example, the output control unit 204 may set colors to respective combinations of the angle of the end effector 102 at the gripping and the angle of the end effector 102 at the packing, and display the pixels corresponding to the gripping position and the packing position with a color corresponding to the respective optimum angles. The output control unit 204 may display the depth images of the container 160 and 170 by being overlapped with the image displaying the evaluation results.

As described above, the controller according to the first embodiment plans (infers) the plan of the gripping position, the gripping posture, the packing position, and the packing posture using the state information about the object before transportation and the state information about the transportation destination. As a result, efficient packing can be planned that can be performed by the robot and has a high occupancy rate or is performed in a short working time. As a result, the processing to transport the objects such as articles can be efficiently performed.

### Second Embodiment

A controller according to a second embodiment includes a function of further correcting the result (plan) obtained by the inference unit.

FIG. 8 is a block diagram illustrating an exemplary structure of a controller 120-2 according to the second embodiment. As illustrated in FIG. 8, the controller 120-2 includes the acquisition unit 201, the inference unit 202, a robot control unit 203-2, the output control unit 204, a correction unit 205-2, the reward determination unit 211, a learning unit 212-2, and the storage 221.

The second embodiment differs from the first embodiment in that the correction unit 205-2 is added, and the robot control unit 203-2 and the learning unit 212-2 each have the different function from that in the first embodiment. Other structural components and functions are the same as those in FIG. 2, which is the block diagram of the controller 120 in the first embodiment, and those are labeled with the same numerals, and descriptions thereof are omitted.

The correction unit 205-2 calculates correction values of the gripping position, the gripping posture, the packing position, and the packing posture that are planned by the inference unit 202 using the state information S₁ input from the acquisition unit 201 and the state information S₂ input from the acquisition unit 201. For example, the correction unit 205-2 inputs the state information S₁ and the state information S₂ to a neural network (the second neural network), and obtains the output information (the second output information) that includes correction values used for correcting the gripping position and the gripping posture (the first position and the first posture) and the packing position and the packing posture (the second position and the second posture) from the output of the neural network with respect to the input. The neural network used by the correction unit 205-2 can include one or more convolution layers, one or more pooling layers, and one or more fully connected layers.

The correction values of the gripping position and the gripping posture are correction values for the coordinate values that are calculated by the inference unit 202 and determine the position of the end effector 102 when gripping the object 161. The correction values of the gripping position and posture may further include correction values of the orientation or the inclination of the end effector 102 when gripping the object 161.

The correction values of the packing position and the packing posture are correction values for the coordinate values that are calculated by the inference unit 202 and determine the position of the end effector 102 when placing the object 161. The correction values of the packing position and the packing posture may further include correction values of the orientation or the inclination of the end effector 102 when placing the object 161.

The robot control unit 203-2 corrects the output information from the inference unit 202 by the correction values obtained by the correction unit 205-2, and controls the robot 100 such that the robot 100 grips and packs the object 161 at the planned positions and postures on the basis of the corrected output information.

The learning unit 212-2 differs from the learning unit 212 in the first embodiment in that the learning unit 212-2 further has a function of learning the neural network (the second neural network) used by the correction unit 205-2. When the neural network (the first neural network) used by the inference unit 202 is already learned, the learning unit 212-2 may have only the function of learning the neural network (the second neural network) used by the correction unit 205-2.

The learning unit 212-2 learns the neural network on the basis of the state information S₁, the state information S₂, the reward input from the reward determination unit 211, and the correction values calculated by the learning unit 212-2 in the past, for example. The learning unit 212-2 learns the neural network by backpropagation, for example. The update amounts of the parameters such as the weights and biases of the neural network can be calculated by the method described in Richard S. Sutton and Andrew G. Barto, “Reinforcement Learning: An Introduction” second edition, MIT Press, Cambridge, Mass., 2018, for example.

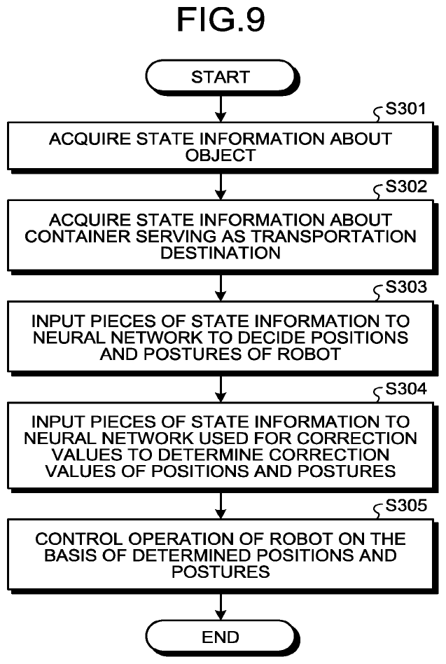

The following describes the control processing by the controller 120-2 thus structured according to the second embodiment with reference to FIG. 9. FIG. 9 is a flowchart illustrating exemplary control processing in the second embodiment.

Processing from step S301 to step S303 is the same as that from step S101 to step S103 in the control processing (FIG. 4) according to the first embodiment. The description thereof is thus omitted.

In the second embodiment, the correction unit 205-2 inputs the acquired state information S₁ and state information S₂ to the neural network (the second neural network), and determines the output information (the second output information) that includes correction values used for correcting the gripping position, the gripping posture, the packing position, and the packing posture of the robot 100 from the output of the neural network (step S304).

The robot control unit 203-2 controls the operation of the robot 100 such that the robot 100 achieves the gripping position, the gripping posture, the packing position, and the packing posture that are corrected by the determined correction values (step S305).

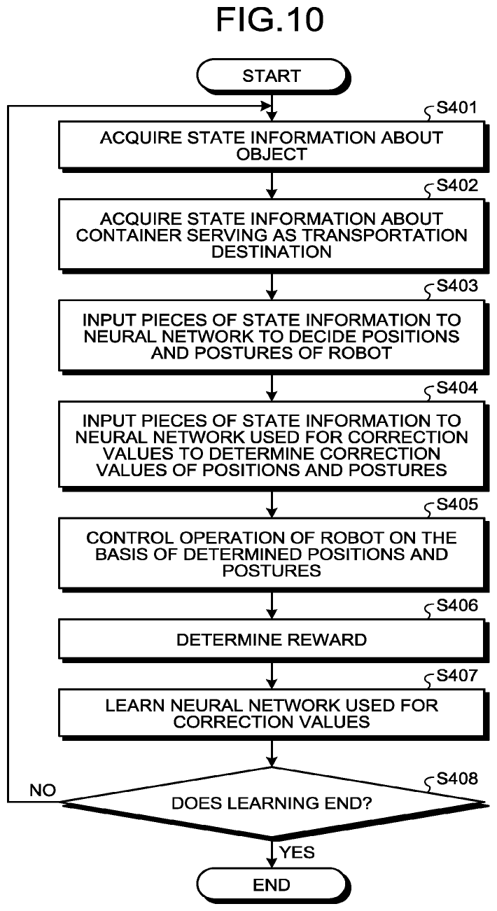

The following describes the learning processing by the controller 120-2 thus structured according to the second embodiment with reference to FIG. 10. FIG. 10 is a flowchart illustrating exemplary learning processing in the second embodiment. FIG. 10 illustrates an example of processing where the neural network (the second neural network) used by the correction unit 205-2 is learned.

The acquisition unit 201 acquires the state information S₁ about the object 161 from the generation unit 110 (step S401). The acquisition unit 201 acquires the state information S₂ about the container 170 serving as the transportation destination from the generation unit 111 (step S402).

The learning unit 212-2 inputs the acquired state information S₁ and state information S₂ to the neural network (the first neural network) used by the inference unit 202, and determines the gripping position, the gripping posture, the packing position, and the packing posture of the robot 100 from the output of the neural network (step S403).

The learning unit 212-2 inputs the acquired state information S₁ and state information S₂ to the neural network (the second neural network) used by the correction unit 205-2, and determines the correction values of the gripping position, the gripping posture, the packing position, and the packing posture from the output of the neural network (step S404).

The robot control unit 203 corrects the gripping position, the gripping posture, the packing position, and the packing posture that are determined at step S403 using the correction values determined at step S404, and controls the operation of the robot 100 such that the robot 100 achieves the corrected gripping position, gripping posture, packing position, and packing posture (step S405).

The reward determination unit 211 determines the value of the reward on the basis of the operation result of the robot 100 (step S406). The learning unit 212-2 updates the weights and biases of the neural network by backpropagation using the value of the reward and the output of the neural network (the second neural network) (step S407).

The learning unit 212-2 determines whether the learning ends (step S408). If the learning continues (No at step S408), the processing returns to step S401, where the processing is repeated. If it is determined that the learning ends (Yes at step S408), the learning processing ends.

The structure including the correction unit 205-2 is effective when the operation of the robot 100 is restricted by a location (position) as described in the following cases.

A case where a range of an incident angle when the end effector 102 is transported to a position far from the robot 100 is smaller than a range of the incident angle when the end effector 102 is transported to a position near the robot 100.

A case where the angle at which the end effector 102 can be rotated while horizontally gripping the object 161 varies depending on the packing position.

The intermediate layer of the neural network (the first neural network) used by the inference unit 202 is composed of only the convolution layers or only the convolution layers and the pooling layers. Such a structure achieves efficient learning but a difference in restriction for each position cannot be considered. The correction unit 205-2 causes the neural network (the second neural network) to learn only the correction values for each position, and the plan output by the inference unit 202 is corrected using the neural network having learned the correction values. As a result, a difference in restriction for each position can be considered.

As described above, according to the first and the second embodiments, the processing to transport objects such as articles can be performed efficiently.

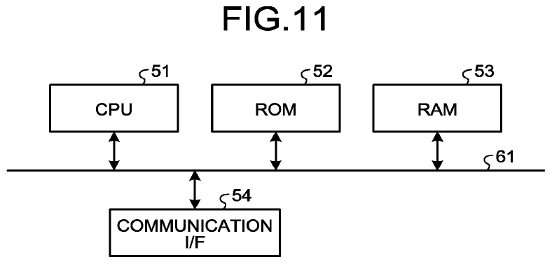

The following describes a hardware structure of the controller according to the first or the second embodiment with reference to FIG. 11. FIG. 11 is an explanatory view illustrating an exemplary hardware structure of the controller according to the first or the second embodiment.

The controller according to the first or the second embodiment includes a control device such as a central processing unit 51, a storage devices such as a read only memory (ROM) 52 and a random access memory (RAM) 53, a communication interface (I/F) 54 that is connected to a network to perform communications, and a bus 61 that connects the respective units.

The program executed by the controller in the first or the second embodiment is preliminarily embedded and provided in the ROM 52, for example.

The program executed by the controller in the first or the second embodiment may be recorded in a computer-readable recording medium such as a compact disc read only memory (CD-ROM), a flexible disk (FD), a compact disc recordable (CD-R), and a digital versatile disc (DVD), as an installable or executable file, and provided as a computer program product.

The program executed by the controller in the first or the second embodiment may be stored in a computer connected to a network such as the Internet and provided by being downloaded via the network. The program executed by the controller in the first or the second embodiment may be provided or distributed via a network such as the Internet.

The program executed by the controller in the first or the second embodiment can cause a computer to function as the respective units of the controller described above. The computer allows the CPU 51 to read the program from a computer readable storage medium to a main storage device and to execute the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A controller, comprising:
one or more processors configured to:
acquire first state information indicating a state of an object to be gripped by a robot and second state information indicating a state of a transportation destination of the object;
input the first state information and the second state information to a first neural network, and obtain, from output of the first neural network, first output information including a first position indicating a position of the robot and a first posture indicating a posture of the robot when the robot grips the object, and a second position indicating a position of the robot and a second posture indicating a posture of the robot at the transportation destination of the object; and
control operation of the robot on the basis of the first output information.

2. The controller according to claim 1, wherein
the first output information includes an evaluation value for each combination of the first position, the first posture, the second position, and the second posture, and
the one or more processors control the operation of the robot on the basis of the first position, the first posture, the second position, and the second posture that are included in a combination having a larger evaluation value than the evaluation values of other combinations.

3. The controller according to claim 2, wherein the one or more processors output the evaluation value.

4. The controller according to claim 1, wherein the one or more processors input the first state information and the second state information having sizes different from the sizes of the first state information and the second state information that were input at learning and obtains the first output information.

5. The controller according to claim 4, wherein the one or more processors learn the first neural network using the first state information and the second state information each size of which is increased as the learning advances.

6. The controller according to claim 1, wherein the one or more processors
input the first state information and the second state information to a second neural network, and obtain, from output of the second neural network, second output information including correction values of the first position, the first posture, the second position, and the second posture,
correct the first output information by the second output information, and
control the operation of the robot on the basis of the corrected first output information.

7. The controller according to claim 6, wherein the one or more processors learn the second neural network.

8. The controller according to claim 1, wherein the first neural network includes a convolution layer or the convolution layer and a pooling layer.

9. A control method, comprising:
acquiring first state information indicating a state of an object to be gripped by a robot and second state information indicating a state of a transportation destination of the object;
inputting the first state information and the second state information to a first neural network, and obtaining, from output of the first neural network, first output information that includes a first position indicating a position of the robot and a first posture indicating a posture of the robot when the robot grips the object, and a second position indicating a position of the robot and a second posture indicating a posture of the robot at the transportation destination of the object; and
controlling operation of the robot on the basis of the first output information.

10. A computer program product having a non-transitory computer readable medium including programmed instructions, wherein the instructions, when executed by a computer, cause the computer to perform:
acquiring first state information indicating a state of an object to be gripped by a robot and second state information indicating a state of a transportation destination of the object;
inputting the first state information and the second state information to a first neural network, and obtains, from output of the first neural network, first output information including a first position indicating a position of the robot and a first posture indicating a posture of the robot when the robot grips the object, and a second position indicating a position of the robot and a second posture indicating a posture of the robot at the transportation destination of the object; and
controlling operation of the robot on the basis of the first output information.
